(19) United States
(12) Patent Application Publication
(10) Pub. No.: US 2025/0227422 A1
(43) Pub. Date: Jul. 10, 2025

(54) FLANGED EARBUD AND EAR-WEARABLE ELECTRONIC DEVICE INCLUDING SAME

(71) Applicant: Starkey Laboratories, Inc., Eden Prairie, MN (US)

(72) Inventors: Craig Feldsien, Prior Lake, MN (US); Sidney A. Higgins, Maple Grove, MN (US); Jacques Andre Grange, Wales (GB); David Tourtelotte, Eden Prairie, MN (US)

(21) Appl. No.: 19/013,047

(22) Filed: Jan. 8, 2025

Related U.S. Application Data
(60) Provisional application No. 63/619,174, filed on Jan. 9, 2024.

(51) Int. Cl. H04R 25/00

(52) U.S. Cl. CPC H04R 25/654

(57) ABSTRACT

Various embodiments of an earbud and an ear-wearable electronic device that includes such earbud are disclosed. The earbud includes an elongated body having a first end, a second end, a cavity extending along a body axis between the first end and the second end of the elongated body, and a body acoustic port disposed in the first end of the body and acoustically coupled to the cavity of the body. A portion of the cavity adjacent the body acoustic port includes a cross-sectional area in a plane orthogonal to the body axis that increases in a direction from the second end of the body to the first end of the body. The earbud further includes a flange connected to the elongated body and a wax bridge disposed on an outer surface of the flange along the body axis and over the body acoustic port.

### RELATED PATENT DOCUMENTS

This application claims the benefit of U.S. Provisional Application No. 63/619,174, filed on Jan. 9, 2024, which is incorporated herein by reference in its entirety.

### BACKGROUND

Ear-wearable electronic devices such as hearing devices and hearing assistance devices can include an earbud that is configured to be adjacent to or inserted into an car canal of a wearer. Such earbuds typically include one of two different types of configurations. The first configuration is an open design where acoustic information from the device can be directed into the car canal of the wearer along with ambient sound from the wearer's environment. For earbuds that are at least partially inserted into the car canal, one or more vents may be formed in the earbud that allow the ambient sound to be transmitted from the wearer's environment into the car canal and received by the wearer. The second configuration is an occluded design that also delivers acoustic information from the device into the car canal of the wearer while substantially or completely sealing the car canal such that most or all ambient sound from the wearer's environment does not reach the car canal.

Hearing assistance devices that include one or more of these earbuds are electroacoustic devices that amplify sound for the wearer to correct hearing deficits as measured by audiometry, usually with the primary purpose of making speech more intelligible. Certain types of hearing assistance devices utilize the earbud that is placed in the wearer's ear canal that conducts the sound produced by the device's receiver (i.e., loudspeaker). A receiver-in-canal (RIC) hearing assistance device has a small body or module that sits behind the car and houses the device's microphone and audio processing circuitry. The receiver of the RIC hearing assistance device is attached to the earbud inside the car and is connected to the body of the device by a slim tube that houses the receiver wiring. Other types of hearing assistance devices may incorporate the receiver into the body behind the car that then conducts sound to an earbud inside the car via an audio tube.

### SUMMARY

In general, the present disclosure provides various embodiments of an earbud and an car-wearable electronic device system that includes such earbud. In one or more embodiments, the earbud can completely occlude an ear canal and allow targeted sound adjustment through an effective seal of the car canal. The earbud can include a wax bridge that is configured to collect debris such as wax and prevent such debris from at least partially occluding an opening or acoustic port of the earbud. Further, one or more embodiments of earbuds described herein can be removed from an car-wearable electronic device, cleaned to remove collected debris, and reconnected to the car-wearable electronic device using any suitable technique.

In one aspect, the present disclosure provides an earbud for insertion into an car canal. The earbud includes an elongated body having a first end, a second end, a cavity extending along a body axis between the first end and the second end of the elongated body, and a body acoustic port disposed in the first end of the body and acoustically coupled to the cavity of the body. A portion of the cavity adjacent the body acoustic port includes a cross-sectional area in a plane orthogonal to the body axis that increases in a direction from the second end of the body to the first end of the body. The earbud further includes a flange connected to the elongated body and includes a first end adjacent the first end of the elongated body, a second end, and an opening disposed in the first end of the flange that is acoustically coupled to the cavity of the elongated body. The earbud further includes a wax bridge disposed on an outer surface of the flange along the body axis and over the body acoustic port.

In another aspect, the present disclosure provides an car-wearable electronic device that includes a housing having a housing acoustic port, an electronic component disposed within the housing, and an earbud connected to the housing and configured to be inserted into an car canal. The earbud includes an elongated body having a first end, a second end, a cavity extending along a body axis between the first end and the second end of the elongated body, and a body acoustic port disposed in the first end of the body and acoustically coupled to the cavity of the body. A portion of the cavity adjacent the body acoustic port includes a cross-sectional area in a plane orthogonal to the body axis that increases in a direction from the second end of the body to the first end of the body. Further, the cavity is acoustically coupled to the housing acoustic port. The earbud further includes a flange connected to the elongated body and includes a first end adjacent the first end of the elongated body, a second end, and an opening disposed in the first end of the flange that is acoustically coupled to the cavity of the elongated body. The earbud further includes a wax bridge disposed on an outer surface of the flange along the body axis and over the body acoustic port.

In another aspect, the present disclosure provides a method that includes disposing a cavity through an elongated body of an earbud along a body axis that extends between a first end and a second end of the elongated body; disposing a body acoustic port in the first end of the body that is acoustically coupled to the cavity of the body, where a portion of the cavity adjacent the body acoustic port includes a cross-sectional area in a plane orthogonal to the body axis that increases in a direction from the second end of the body to the first end of the body; and connecting a first end of a flange to the first end of the elongated body, where the flange extends along the body axis between the first end and a second end, and where the flange further includes an opening disposed in the first end of the flange that is acoustically coupled to the cavity of the body. The method further includes disposing a wax bridge on an outer surface of the flange along the body axis and over the body acoustic port.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or clement or group of steps or elements but not the exclusion of any other step or clement or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of an ear-wearable electronic device system that includes an ear-wearable electronic device and an earbud connected to a housing of the ear-wearable electronic device.

FIG. 2 is a schematic cross-section view of the ear-wearable electronic device and the earbud of the system of FIG. 1 with a wax bridge of the earbud removed for explanatory purposes.

FIG. 3 is a schematic cross-section view of the earbud of the system of FIG. 1.

FIG. 4 is a schematic perspective cross-section view of the earbud of the system of FIG.

FIG. 5 is a schematic cross-section view of the earbud of the system of FIG. 1 and another embodiment of a wax bridge disposed on an outer surface of a flange of the earbud.

FIG. 6 is a schematic perspective cross-section view of the earbud of the system of FIG. 1 and another embodiment of a wax bridge disposed on the outer surface of the flange of the earbud. 1.

FIG. 7 is a schematic perspective cross-section view of the earbud of the system of FIG. 1 and another embodiment of a wax bridge disposed on the outer surface of the flange of the earbud.

FIG. 8 is a flowchart of one embodiment of a technique that can be utilized with the ear-wearable electronic device system of FIG. 1.

### DETAILED DESCRIPTION

In general, the present disclosure provides various embodiments of an earbud and an ear-wearable electronic device system that includes such earbud. In one or more embodiments, the earbud can completely occlude an ear canal and allow targeted sound adjustment through an effective seal of the ear canal. The earbud can include a wax bridge that is configured to collect debris such as wax and prevent such debris from at least partially occluding an opening or acoustic port of the earbud. Further, one or more embodiments of earbuds described herein can be removed from an ear-wearable electronic device, cleaned to remove collected debris, and reconnected to the ear-wearable electronic device using any suitable technique.

The various earbuds described herein can be utilized with any suitable ear-wearable electronic device system that includes any suitable ear-wearable electronic device. As used herein, the term “car-wearable electronic device” means a device for providing audio-related content to a wearer. The car-wearable electronic device system can include any suitable device for providing this audio-related content, e.g., a smartphone, radio, personal music player, hearing assistance device (e.g., hearing aid), etc. In one or more embodiments, the car-wearable electronic device can include a consumer electronic wearable audio device having various functionalities, e.g., headphones. In one or more embodiments, the ear-wearable electronic device may assist or augment the auditory environment of the wearer or otherwise provide audio content to the wearer. The car-wearable electronic device may provide a processed version of the audio content heard by the wearer to enhance the auditory experience of the wearer (e.g., compensating for a hearing impairment). For example, the car-wearable electronic device may provide audio content to the wearer based on data received from another device or system, locally or over the internet, by the car-wearable electronic device (e.g., a direct or composite room microphone feed, a videoconference audio stream, a teleconference audio stream, background music, or advertising). The car-wearable electronic device may have one or more settings that can be changed based on one or more hearing program parameters.

An car-wearable electronic device may include hearing assistance devices, or hearing aids of various types, such as behind-the-car (BTE), in-the-car (ITE), in-the-canal (ITC), receiver-in-canal (RIC), or completely-in-the-canal (CIC) type hearing aids. It is understood that BTE type hearing aids may include devices or modules that reside substantially behind the car or over the car. Such devices may include hearing aids with receivers associated with the electronics portion of the device or hearing aids of the type having receivers in the car canal of the wearer, including but not limited to receiver-in-canal (RIC) or receiver-in-the-car (RITE) designs. The present subject matter can also be used in hearing assistance devices generally, such as cochlear implant type car-wearable electronic devices and deep insertion devices having a transducer, such as a receiver or microphone, whether custom fitted, standard, open fitted, or occlusive fitted. It is understood that other devices not expressly stated herein may also be used with the present subject matter.

In one or more embodiments, the hearing assistance device can include one or more of the following: an input transducer for converting an audio input into an input signal; a digital signal processor (DSP) for processing the input signal into an output signal in a manner that compensates for a wearer's hearing deficit; an audio amplifier and receiver for converting the output signal into an audio output; and an earbud as described herein attached to the receiver. Hearing assistance devices typically include an enclosure or housing, a microphone, hearing assistance device electronics or components, including processing electronics, and a speaker or receiver. It is understood that in various embodiments the microphone is optional. Further, it is understood that in various embodiments the receiver is optional. Such devices may include antenna configurations, which may vary and may be included within an enclosure for the electronics or be external to an enclosure for the electronics. Thus, the various embodiments described herein are intended to be demonstrative and not a limiting or exhaustive depiction of variations.

It is further understood that any car-wearable electronic device may be used without departing from the scope, and the devices depicted in the figures are intended to demonstrate the subject matter, but not in a limited, exhaustive, or exclusive sense. It is also understood that the present subject matter can be used with a device designed for use in the right car or the left ear or both cars of the wearer.

It is further understood that car-wearable electronic devices include a processor. In digital hearing devices with a processor programmed to provide corrections to hearing impairments, programmable gains are employed to tailor the device output to a wearer's particular hearing impairment. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, and certain types of filtering and processing. In various embodiments the processor is configured to perform instructions stored in memory that may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

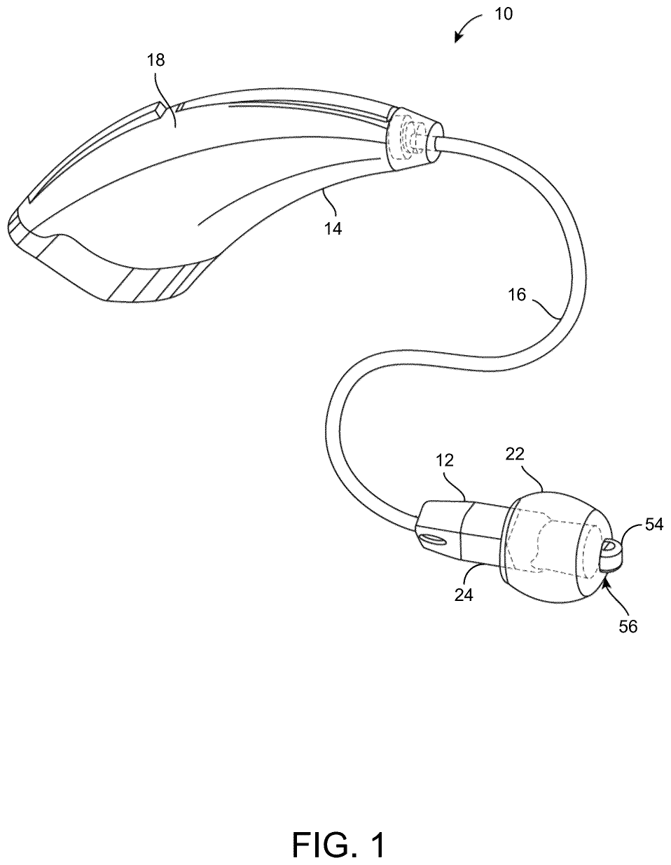

FIG. 1 is a schematic perspective view of one embodiment of an car-wearable electronic device system 10. The system 10 includes an car-wearable electronic device 12, a hearing module 14, and a cable 16 that connects the car-wearable electronic device to the hearing module. The hearing module 14 is configured to be disposed between an car and a skull of a wearer. As is further described herein, the hearing module 14 includes a module housing 18 and electronic components disposed within the module housing. Any suitable electronic components can be included on or at least partially within the housing 18 of the module 14, e.g., the same electronic components described herein regarding the car-wearable electronic device 12. The car-wearable electronic device 12 also includes an earbud 22 connected to a first end 24 of a housing 26 of the device.

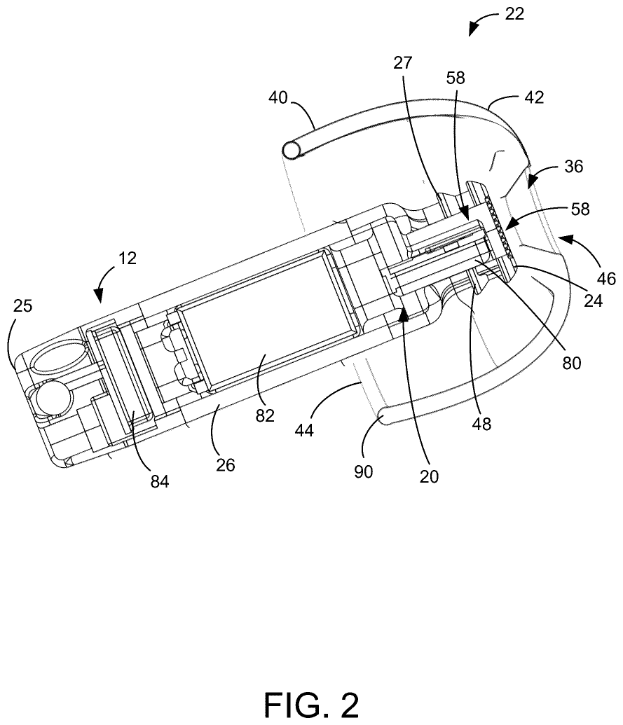

The car-wearable electronic device 12 can include any suitable device that can provide acoustic energy to the wearer using any suitable technique, e.g., by directing sound into the car of the wearer, bone conduction, implants, etc. For example, the car-wearable electronic device 12 can include one or more embodiments of car-wearable electronic devices described in U.S. patents application Ser. No. 18/121,317, filed Mar. 14, 2023, and entitled EAR-WEARABLE ELECTRONIC DEVICE; Ser. No. 18/121,325, filed Mar. 14, 2023, and entitled EAR-WEARABLE ELECTRONIC DEVICE; and Ser. No. 18/369,865, filed Sep. 19, 2023, and entitled EAR-WEARABLE ELECTRONIC DEVICE. In one or more embodiments, the car-wearable electronic device 12 can include one or more microphones 80 (FIG. 2) that are configured to be disposed within the car canal facing an eardrum of an car of a wearer.

Further, the system 10 can include a hearing assistance device such as behind-the-car (BTE), in-the-car (ITE), in-the-canal (ITC), or completely-in-the-canal (CIC) type car-wearable electronic devices. It is understood that behind-the-car type car-wearable electronic devices can reside substantially behind the car or over the car. Such devices can include receivers associated with an electronics portion of the behind-the-car device, or receivers disposed in the car canal of the wearer. Such devices are also known as receiver-in-the-canal (RIC) or receiver-in-the-car (RITE) car-wearable electronic devices. Although the system 10 includes the module 14 and the cable 16, in one or more embodiments, the module and cable may not be required so that the system is the car-wearable electronic device 12 and optionally a remotely connected processor or source such as a smartphone.

The car-wearable electronic device 12 can include the housing 26 that has a housing acoustic port 58 and one or more electronic components 20 disposed within the housing (FIG. 2). The housing acoustic port 58 can be acoustically coupled to at least one of the one or more electronic components 20.

The electronic components 20 can include any suitable electronic component or circuitry, e.g., one or more of the electronic components described in U.S. patent application Ser. No. 18/369,865 to Higgins et al. and entitled HEARING DEVICE. In general, the electronic components can include at least one of a controller, an integrated circuit, a power source, a microphone, or a speaker (i.e., receiver). For example, the device 12 can include a microphone 80 disposed within the housing 26 adjacent the housing acoustic port 58, a receiver 82 disposed in the housing, and an optional rear microphone 84 disposed within the housing and adjacent a second end 25 of the housing. In one or more embodiments, at least one of the microphone 80, receiver 82, or rear microphone 84 of the electronic components 20 can be acoustically coupled to the housing acoustic port 58 using any suitable technique. As used herein, the term “acoustically coupled” means fluidically coupled or that any barrier positioned between two or more elements or components that are acoustically coupled is generally acoustically transparent for frequencies of interest, where acoustically transparent means that the element or component attenuates sound at a sound pressure level of no greater than 6 dB.

The earbud 22 is connected to any suitable portion or portions of the housing 26 of the device 12 using any suitable technique as is further described herein. In one or more embodiments, the earbud 22 is connected to the first end 24 of the housing 26.

The earbud 22 can take any suitable shape and have any suitable dimensions. In one or more embodiments, the earbud 22 is integral with the housing 26, i.e., formed as a single part with the housing during the manufacturing process. In one or more embodiments, the earbud 22 can be manufactured separately from the housing 26 and connected to the housing using any suitable technique.

The earbud 22 can be configured for insertion into an car canal. As shown in FIGS. 2-4, the earbud 22 includes an elongated body 28 having a first end 30, a second end 32, and a cavity 34 that extends along a body axis 2 between the first end and the second end of the elongated body. The cavity 34 can be acoustically coupled to the housing acoustic port 58 of the housing 26 of the car-wearable electronic device 12 (FIG. 2) using any suitable technique. The elongated body 28 also includes a body acoustic port 36 disposed in the first end 30 of the body and acoustically coupled to the cavity 34 of the body. A portion 38 of the cavity 34 adjacent the body acoustic port 36 includes a cross-sectional area in a plane orthogonal to the body axis 2 (i.e., a cross-sectional plane) that can, in one or more embodiments, increase in a direction from the second end 32 of the body 28 to the first end 30 of the body. The earbud 22 also includes a flange 40 connected to the elongated body 28. The flange 40 includes a first end 42 adjacent the first end 30 of the elongated body 28, a second end 44, and an opening 46 disposed in the first end 42 of the flange that is acoustically coupled to the cavity 34 of the elongated body 28. In one or more embodiments, the earbud 22 can also include a wax bridge 54 disposed on an outer surface 56 of the flange 40 along the body axis 2 and over the body acoustic port 36 as is further described herein.

The elongated body 28 can include any suitable material, e.g., at least one of an organic (e.g., polymeric) or inorganic (e.g., metallic, ceramic) material. In one or more embodiments, the materials of the elongated body 28 can include any suitable thermoplastic elastomers, thermoplastic polyurethanes, synthetic rubbers, silicones, and combinations thereof.

Further, the elongated body 28 can take any suitable shape. In one or more embodiments, the elongated body 28 includes a cylindrical shape in a plane that is orthogonal to the body axis 2. The elongated body 28 can also have any suitable dimensions. In one or more embodiments, the elongated body 28 can have a cross-sectional area in the plane orthogonal to the body axis 2 that is constant between the first end 30 and the second end 32 of the body. In one or more embodiments, the cross-sectional area of the elongated body 28 can vary between the first end 42 and the second and 44, e.g., the elongated body can have a tapered shape.

The elongated body 28 can also include the cavity 34 disposed within the body. The cavity 34 can extend along the body axis 2 between the first end 30 and the second end 32 of the elongated body. The cavity 34 can take any suitable shape and have any suitable dimensions. In one or more embodiments, the cavity 34 can be configured to receive a housing (e.g., housing 26 of device 12 of FIG. 2). For example, the cavity 34 can include one or more ribs 48 that are configured to engage one or more retainer rings 27 of the housing 26 of the device 12 so that the housing is retained within the earbud 22.

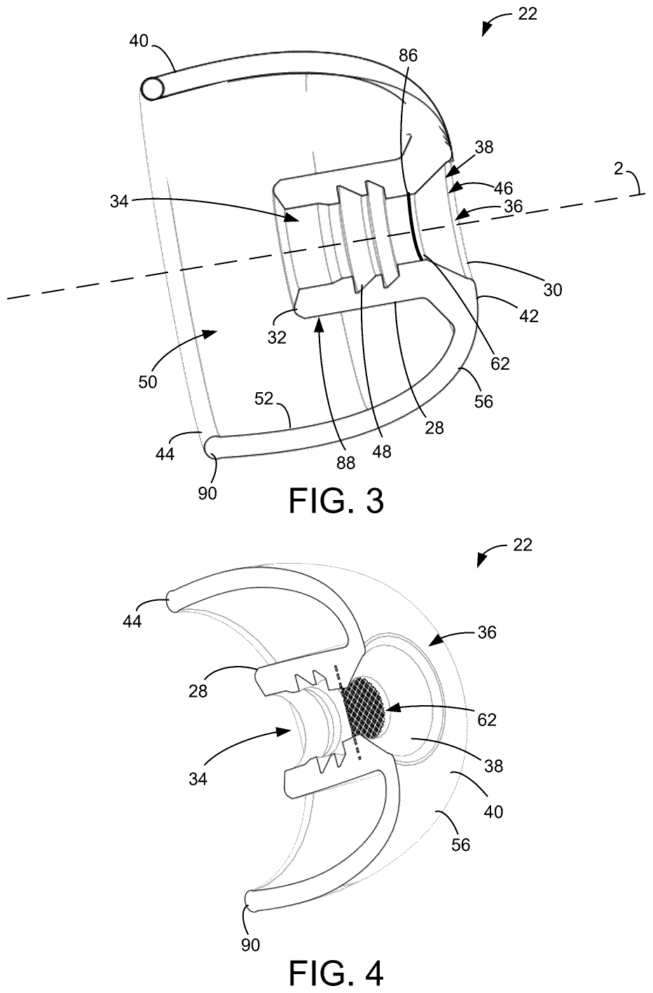

The cavity 34 can have a cross-sectional area in the plane orthogonal to the body axis 2 that is constant along the body axis 2 between the first end 30 and the second and 32 of the elongated body. In one or more embodiments, the cross-sectional area of the cavity 34 can vary along the body axis 2 between the first end 30 and the second end 32 of the elongated body. In one or more embodiments, the portion 38 of the cavity 34 adjacent the body acoustic port 36 can include a cross-sectional area in a plane orthogonal to the body axis 2 that increases in a direction from the second end 32 of the body 28 to the first end 30 of the body. This portion 38 can take any suitable shape. In one or more embodiments, the portion 38 of the cavity 34 takes an inverted cone shape as shown in FIG. 3. This portion 38 can be defined by an opening 86 and the body acoustic port 36. The opening 86 can be considered to be a transition region from a first portion 88 of the cavity 34 and the portion 38 adjacent the acoustic port 36. The opening 86 can have a first diameter, and the acoustic port 36 can have a second diameter.

The elongated body 28 can also include the body acoustic port 36 disposed in the first end 30 of the body. The body acoustic port 36 is acoustically coupled to the cavity 34 of the body 28 and can be configured to direct sound produced by an ear-wearable electronic device that is acoustically coupled to the cavity 34 of the body to the wearer. The body acoustic port 36 can take any suitable shape or shapes and have any suitable dimensions. In one or more embodiments, the body acoustic port 36 can be configured to direct sound from within the car canal to a microphone (e.g., microphone 80 of FIG. 2) disposed at least partially within the car-wearable electronic device 12.

Connected to the elongated body 28 is the flange 40. Although depicted as including a single flange 40, the earbud 22 can include any suitable number of flanges. The flange 40 includes the first end 42 adjacent the first end 30 of the elongated body 28, the second end 44, and the opening 46 that is disposed in the first end 42 of the flange. The flange 40 can be connected to the elongated body 28 in any suitable location along the body. In one or more embodiments, the flange 40 is connected to the elongated body 28 such that the first end 42 is adjacent the first end 30 of the elongated body. The opening 46 is acoustically coupled to the cavity 34 of the elongated body 28. In one or more embodiments, the opening 46 of the flange 40 is in registration with the body acoustic port 36 of the elongated body 28 along the body axis 2.

The flange 40 can include any suitable material, e.g., at least one of an organic (e.g., polymeric) or inorganic (e.g., metallic, ceramic) material. In one or more embodiments, the flange 40 can include at least one of a foam, thermoplastic elastomer, thermoplastic polyurethane, synthetic rubber, silicone, etc. In one or more embodiments, the flange 40 includes the same material as those utilized to form the elongated body 28. In one or more embodiments, the flange 40 is formed of a material that is different from the material utilized to form the elongated body 28. Further, in one or more embodiments, the flange 40 can be integral with the elongated body 28.

The flange 40 can take any suitable shape. As illustrated in FIG. 3, the flange 40 extends radially and distally from the first end 30 of the elongated body 28 and terminates at the second end 44 of the flange and adjacent the second end 32 of the elongated body.

In one or more embodiments, the flange 40 can take a shape such that a cross-sectional circumference of the flange measured in a plane orthogonal to the body axis 2 increases in a direction from the first end 42 to the second end 44 of the flange along the body axis. In one or more embodiments, the cross-sectional circumference of the flange 40 increases in a direction from the first end 42 to a maximum value at an apex of the flange and then decreases to the cross-sectional circumference of the second end 44.

As stated herein, the flange 40 can take any suitable shape. In one or more embodiments, the flange 40 can have a circular or elliptical cross-section in the plane orthogonal to the body axis 2. In one or more embodiments, the flange 40 can have a constant thickness. In one or more embodiments, one or more portions of the flange 40 can have a thickness that is different from the thickness of one or more additional portions of the flange.

The flange 40 can also include a retainer ring 90 disposed at the second end 44 of the flange. When the flange 40 includes the retainer ring 90, such ring can at least in part define the second end 44 of the flange. The retainer ring 90 can be connected to the flange 40 using any suitable technique. In one or more embodiments, the retainer ring 90 is integral with the flange 40. Further, the retainer ring 90 can take any suitable shape and have any suitable dimensions. In one or more embodiments, a cross-sectional thickness of the retainer ring 90 can be greater than a cross-sectional thickness of the flange 40. In one or more embodiments, the cross-sectional thickness of the retainer ring 90 can be less than the cross-sectional thickness of the flange 40.

Further, the flange 40 can include a flange cavity 50 disposed between an inner surface 52 of the flange and the body 28 such that at least a portion of the flange can collapse towards the body axis 2 when the flange is inserted into the car canal. The flange cavity 50 can take any suitable shape and have any suitable dimensions.

In one or more embodiments, the flange 40 can include a mesh 62 that is disposed on or at least partially within the earbud 22. Any suitable mesh can be utilized, e.g., a polymeric mesh. The mesh 62 can be disposed in or on any suitable portion or portions of the earbud 22. In one or more embodiments, at least a portion of the mesh 62 can be disposed over the body acoustic port 36 of the elongated body 28 to prevent ingress of debris into the cavity 34. In one or more embodiments, the mesh 62 can be at least partially embedded within the elongated body 28 and extend through the cavity 34 as shown in FIGS. 3-4. In such embodiments, the mesh 62 can be disposed at any suitable distance from the body acoustic port 36 of the elongated body 28.

The earbud 22 can also include an optional wax bridge 54 (FIG. 1) disposed on an outer surface 56 of the flange 40 along the body axis 2 and over the opening 46 of the flange. The wax bridge 54 can prevent direct line-of-sight wax ingress into the cavity 34 of the elongated body 28. The wax bridge 54 can be connected to the flange 40 using any suitable technique. In one or more embodiments, the wax bridge 54 is integral with the flange 40. In one or more embodiments, the wax bridge 54 can be connected to the elongated body 28 using any suitable technique. For example, the wax bridge 54 can be connected to the body acoustic port 36 and extend at least partially through the opening 46 of the flange 40.

The wax bridge 54 can include any suitable material, e.g., at least one of an organic (e.g., polymeric) or inorganic (e.g., metallic, ceramic) material. In one or more embodiments, the wax bridge 54 can include the same material as at least one of the elongated body 28 or the flange 40. In one or more embodiments, the wax bridge 54 can be integral with at least one of the elongated body 28 or the flange 40.

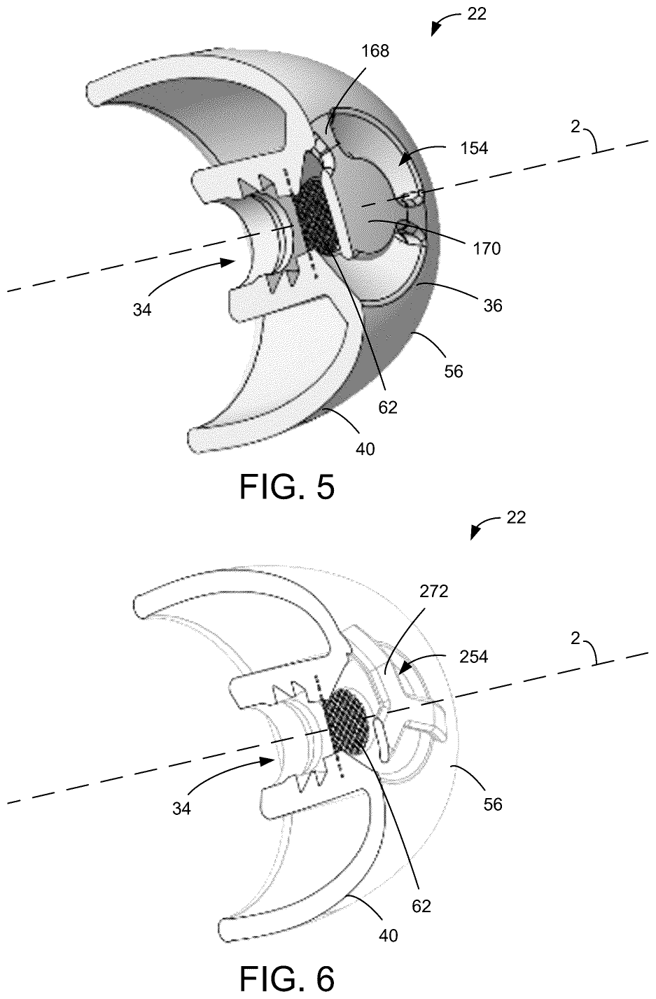

The wax bridge 54 can take any suitable shape. For example, FIG. 5 is a schematic cross-section view of the earbud 22 and another embodiment of a wax bridge 154 connected to the outer surface 56 of the flange 40 of the earbud. All design considerations and possibilities described herein regarding the wax bridge 54 of FIG. 1 apply equally to the wax bridge 154 of FIG. 5 unless stated otherwise. The wax bridge 154 includes a body portion 170 and one or more arms 168 that connect the body portion to the flange 40. In one or more embodiments, the one or more arms 168 can connect the body portion 170 of the wax bridge 154 to the elongated body 28. The one or more arms 168 can include one or more resilient arms. For example, the wax bridge 154 can be connected to the outer surface 56 of the flange 40 by at least one resilient arm 168 that is configured to allow the body portion 170 to collapse towards at least one of the outer surface 56 of the flange 40 or the first end 30 of the elongated body 28 of the earbud 22 when the earbud is inserted into the car canal of the wearer. The wax bridge 154 can include any suitable number of resilient arms having any suitable shape and dimensions.

The body portion 170 can take any suitable shape and have any suitable dimensions. Further, the body portion 170 can be connected to the one or more arms 168 using any suitable technique. In one or more embodiments, the body portion 170 can be integral with the arms 168. The wax bridge 154 is configured to prevent debris from entering the body acoustic port 36 of the cavity 34 of the earbud 22.

FIG. 6 is a schematic cross-section view of another embodiment of a wax bridge 254 disposed on the outer surface 56 of the flange 40 of the earbud 22 or the first end 30 of the elongated body 28. All design considerations and possibilities described herein regarding the wax bridge 154 of FIG. 5 apply equally to the wax bridge 254 of FIG. 6 unless stated otherwise. The wax bridge 254 includes two or more overlapping leaves 272 that are connected to the outer surface 56 of the flange 40 using any suitable technique. In one or more embodiments, the overlapping leaves 272 can be connected to the elongated body 28 of the earbud 22. In one or more embodiments, the overlapping leaves 272 are integral with the flange 40 or the elongated body 28. The wax bridge 254 can include any suitable number of overlapping leaves 272 that each take any suitable shape and have any suitable dimensions. The overlapping leaves 272 are configured to prevent debris from entering the body acoustic port 36 of the cavity 34 of the earbud 22. In one or more embodiments, the overlapping leaves 272 are resilient and configured to collapse towards at least one of the outer surface 56 of the flange 40 or the first end 30 of the elongated body 28 when the earbud 22 is inserted into the car canal of the wearer.

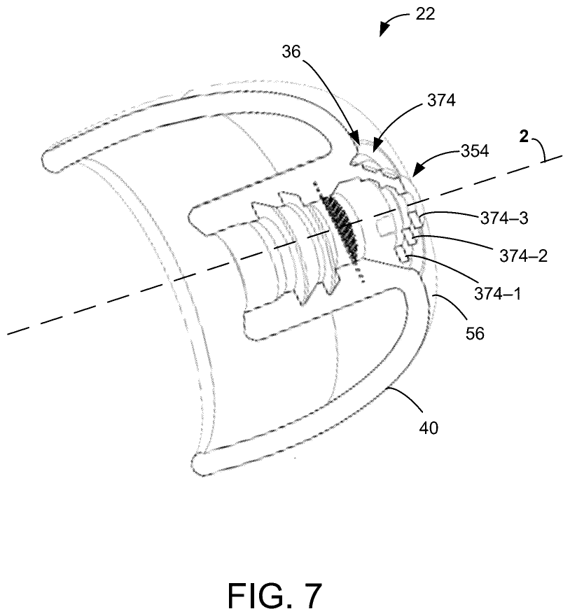

FIG. 7 is a schematic cross-section view of another embodiment of a wax bridge 354 disposed on the outer surface 56 of the flange 40 of the earbud 22. All design considerations and possibilities described herein regarding wax bridge 254 of FIG. 6 apply equally to wax bridge 354 of FIG. 7 unless stated otherwise. The wax bridge 354 includes at least two concentric rings 374 that are connected to the outer surface 56 of the flange 40 using any suitable technique. In one or more embodiments, the concentric rings 374 can be connected to the elongated body 28 of the earbud 22. The wax bridge 354 can include any suitable number of concentric rings 374 each taking any suitable shape. In one or more embodiments, a diameter of a first concentric ring 374-1 disposed closest to the elongated body 28 is greater than a diameter of a second concentric ring 374-2, which in turn is greater than a diameter of a third concentric ring 374-3 that is disposed so that the second concentric ring is disposed between the first concentric ring and the third concentric ring. In other words, the concentric rings 374 decrease in diameter in a direction from the second end 32 of the body 28 to the first end 30 of the body along the body axis 2. The concentric rings 374 are configured to prevent debris from entering the body acoustic port 36 of the cavity 34 of the earbud 22. In one or more embodiments, the concentric rings 374 are resilient and configured to collapse towards at least one the outer surface 56 of the flange 40 or the first end 30 of the elongated body 28 when the earbud is inserted into the car canal of the wearer.

In general, at least one of the body 28, the flange 40, and the wax bridge 54 can be manufactured using any suitable technique. For example, at least one of the body 28, the flange 40, or the wax bridge 54 can be manufactured utilizing, e.g., injection molding, cast molding, transfer molding, 3D printing, etc. In one or more embodiments, the body 28, the flange 40, and the wax bridge 54 can be manufactured separately and then connected together using any suitable technique, e.g., adhering, welding, ultrasonic welding, etc. In one or more embodiments, the body 28 and at least one of the flange 40 or the wax bridge 54 can be integral.

Further, at least one of the body 28, the flange 40, or the wax bridge 54 can be manufactured using a single-shot molding process where the material thicknesses of the body, the flange, and the wax bridge are made utilizing different materials such that the resulting earbud has differing degrees of resilience or stiffness amongst the components. In one or more embodiments, a two-shot or multiple-shot molding process can be utilized such that the body 28 is made from a material that is more stiff than the material of one or both of the flange 40 and the wax bridge 54. Use of a stiffer material for the body 28 can allow it to be constructed with a thinner wall section.

The earbud 22 can be considered to be an occluded design as the flange 40 is continuous and can, therefore, create an acoustic seal against sidewalls of the car canal or at an aperture of the car canal, resulting in a sealed enclosure, which may provide an improved bass response in the car canal. In one or more embodiments, one or more vents can be disposed through the flange to provide an open design or configuration, where such vents can allow ambient sound to enter the car canal of the wearer so that the wearer can hear such ambient sound. As a result, the open design can provide the user with acoustical information from the wearer's environment.

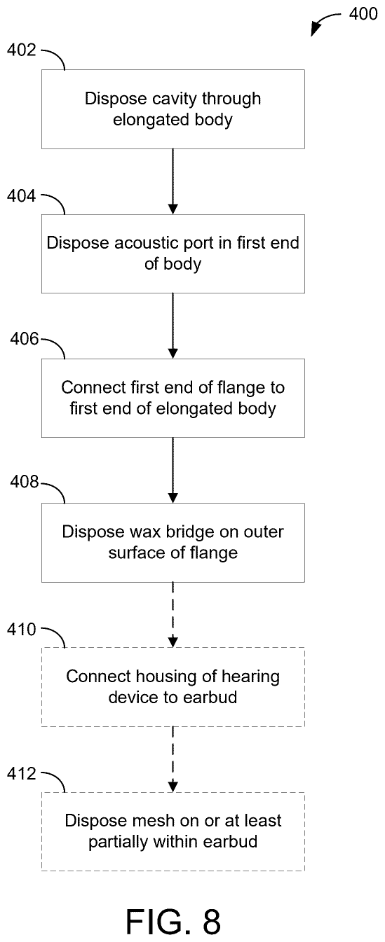

Any suitable technique can be utilized to form the car-wearable electronic device 12. For example, FIG. 8 is a flowchart of one technique 400 that can be utilized for forming the car-wearable electronic device 12. Although described regarding car-wearable electronic device 12 of FIGS. 1-7, the technique 400 can be utilized to form any suitable car-wearable electronic device. At 402, the cavity 34 can be disposed through the elongated body 28 of the earbud 22 along the body axis 2 that extends between the first end 30 and the second end 32 of the elongated body using any suitable technique. At 404, the body acoustic port 36 can be disposed in the first end 30 of the body 28 that is acoustically coupled to the cavity 34 of the body using any suitable technique. The first end 42 of the flange 40 can be connected to the first end 30 of the elongated body 28 at 406 using any suitable technique. Further, at 408, the wax bridge 54 can be disposed on the outer surface 56 of the flange 40 or connected to the elongated body 28 using any suitable technique.

At 410 the housing 26 of the car-wearable electronic device 12 can optionally be connected to the earbud 22 using any suitable technique. Further, at 412, the mesh 62 can be disposed on or at least partially within the earbud 22 using any suitable technique.

Embodiments of the disclosure are defined in the claims; however, herein there is provided a non-exhaustive listing of non-limiting examples. Any one or more of the features of these examples may be combined with any one or more features of another example, embodiment, or aspect described herein.

Example Ex1. An earbud for insertion into an ear canal. The earbud includes an elongated body having a first end, a second end, a cavity extending along a body axis between the first end and the second end of the elongated body, and a body acoustic port disposed in the first end of the body and acoustically coupled to the cavity of the body. A portion of the cavity adjacent the body acoustic port includes a cross-sectional area in a plane orthogonal to the body axis that increases in a direction from the second end of the body to the first end of the body. The earbud further includes a flange connected to the elongated body and includes a first end adjacent the first end of the elongated body, a second end, and an opening disposed in the first end of the flange that is acoustically coupled to the cavity of the elongated body. The earbud further includes a wax bridge disposed on an outer surface of the flange along the body axis and over the body acoustic port.

Example Ex2. The earbud of Ex1, where the wax bridge includes a body portion and an arm that connects the body portion to the flange.

Example Ex3. The earbud of Ex1, where the wax bridge includes two or more overlapping leaves that are connected to the outer surface of the flange.

Example Ex4. The earbud of Ex1, where the wax bridge includes at least two concentric rings that are connected to the outer surface of the flange.

Example Ex5. The earbud of any one of Ex1-Ex4, where the flange further includes a retaining ring disposed at the second end of the flange.

Example Ex6. The earbud of Ex5, where a cross-sectional thickness of the retaining ring is greater than a cross-sectional thickness of the flange.

Example Ex7. The earbud of any one of Ex 1-Ex6, where a cross-sectional circumference of the flange in a plane orthogonal to the body axis increases in a direction from the first end of the flange to the second end of the flange along the body axis. Example Ex8. The earbud of any one of Ex1-Ex7, where the flange is integral with the body.

Example Ex9. The earbud of any one of Ex 1-Ex8, further including a mesh disposed on or at least partially within the earbud.

Example Ex10. The earbud of Ex9, where at least a portion of the mesh is disposed over the body acoustic port of the elongated body.

Example Ex11. The earbud of Ex9, where the mesh is embedded at least partially within the elongated body and extends through the cavity.

Example Ex 12. An ear-wearable electronic device that includes a housing having a housing acoustic port, an electronic component disposed within the housing, and an earbud connected to the housing and configured to be inserted into an ear canal. The earbud includes an elongated body having a first end, a second end, a cavity extending along a body axis between the first end and the second end of the elongated body, and a body acoustic port disposed in the first end of the body and acoustically coupled to the cavity of the body. A portion of the cavity adjacent the body acoustic port includes a cross-sectional area in a plane orthogonal to the body axis that increases in a direction from the second end of the body to the first end of the body. Further, the cavity is acoustically coupled to the housing acoustic port. The earbud further includes a flange connected to the elongated body and includes a first end adjacent the first end of the elongated body, a second end, and an opening disposed in the first end of the flange that is acoustically coupled to the cavity of the elongated body. The earbud further includes a wax bridge disposed on an outer surface of the flange along the body axis and over the body acoustic port.

Example Ex13. The device of Ex12, where the electronic component is acoustically coupled to the body acoustic port of the elongated body via the cavity of the elongated body.

Example Ex14. The device of any one of Ex12-Ex13, where the wax bridge includes a body portion and an arm that connects the body portion to the flange.

Example Ex15. The device of Ex12, where the wax bridge includes two or more overlapping leaves that are connected to the outer surface of the flange.

Example Ex16. The device of Ex12, where the wax bridge includes at least two concentric rings that are connected to the outer surface of the flange.

Example Ex17. The device of any one of Ex12-Ex16, further including a mesh disposed on or at least partially within the earbud.

Example Ex18. The device of Ex17, where at least a portion of the mesh is disposed over the body acoustic port of the elongated body.

Example Ex19. The device of Ex 17, where the mesh is embedded within the elongated body and extends through the cavity.

Example Ex21. A method that includes disposing a cavity through an elongated body of an earbud along a body axis that extends between a first end and a second end of the elongated body; disposing a body acoustic port in the first end of the body that is acoustically coupled to the cavity of the body, where a portion of the cavity adjacent the body acoustic port includes a cross-sectional area in a plane orthogonal to the body axis that increases in a direction from the second end of the body to the first end of the body; and connecting a first end of a flange to the first end of the elongated body, where the flange extends along the body axis between the first end and a second end, and where the flange further includes an opening disposed in the first end of the flange that is acoustically coupled to the cavity of the body. The method further includes disposing a wax bridge on an outer surface of the flange along the body axis and over the body acoustic port.

Ex21. The method of Ex20, further including connecting a housing of an ear-wearable electronic device to the earbud.

Ex22. The method of any one of Ex20-Ex21, further including disposing a mesh on or at least partially within the earbud.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An earbud for insertion into an ear canal, comprising:
an elongated body comprising a first end, a second end, a cavity extending along a body axis between the first end and the second end of the elongated body, and a body acoustic port disposed in the first end of the body and acoustically coupled to the cavity of the body, wherein a portion of the cavity adjacent the body acoustic port comprises a cross-sectional area in a plane orthogonal to the body axis that increases in a direction from the second end of the body to the first end of the body;
a flange connected to the elongated body and comprising a first end adjacent the first end of the elongated body, a second end, and an opening disposed in the first end of the flange that is acoustically coupled to the cavity of the elongated body; and
a wax bridge disposed on an outer surface of the flange along the body axis and over the body acoustic port.

2. The earbud of claim 1, wherein the wax bridge comprises a body portion and an arm that connects the body portion to the flange.

3. The earbud of claim 1, wherein the wax bridge comprises two or more overlapping leaves that are connected to the outer surface of the flange.

4. The earbud of claim 1, wherein the wax bridge comprises at least two concentric rings that are connected to the outer surface of the flange.

5. The earbud of claim 1, wherein the flange further comprises a retaining ring disposed at the second end of the flange.

6. The earbud of claim 5, wherein a cross-sectional thickness of the retaining ring is greater than a cross-sectional thickness of the flange.

7. The earbud of claim 1, wherein a cross-sectional circumference of the flange in a plane orthogonal to the body axis increases in a direction from the first end of the flange to the second end of the flange along the body axis.

8. The earbud of claim 1, further comprising a mesh disposed on or at least partially within the earbud.

9. The earbud of claim 8, wherein at least a portion of the mesh is disposed over the body acoustic port of the elongated body.

10. The earbud of claim 8, wherein the mesh is embedded at least partially within the elongated body and extends through the cavity.

11. An ear-wearable electronic device comprising:
a housing comprising a housing acoustic port;
an electronic component disposed within the housing; and
an earbud connected to the housing and configured to be inserted into an ear canal, the earbud comprising:
an elongated body comprising a first end, a second end, a cavity extending along a body axis between the first end and the second end of the elongated body, and a body acoustic port disposed in the first end of the body and acoustically coupled to the cavity of the body, wherein a portion of the cavity adjacent the body acoustic port comprises a cross-sectional area in a plane orthogonal to the body axis that increases in a direction from the second end of the body to the first end of the body, and further wherein the cavity is acoustically coupled to the housing acoustic port;
a flange connected to the elongated body and comprising a first end adjacent the first end of the elongated body, a second end, and an opening disposed in the first end of the flange that is acoustically coupled to the cavity of the elongated body; and
a wax bridge disposed on an outer surface of the flange along the body axis and over the body acoustic port.

12. The device of claim 11, wherein the electronic component is acoustically coupled to the body acoustic port of the elongated body via the cavity of the elongated body.

13. The device of claim 11, wherein the wax bridge comprises a body portion and an arm that connects the body portion to the flange.

14. The device of claim 11, wherein the wax bridge comprises two or more overlapping leaves that are connected to the outer surface of the flange.

15. The device of claim 11, wherein the wax bridge comprises at least two concentric rings that are connected to the outer surface of the flange.

16. The device of claim 11, further comprising a mesh disposed on or at least partially within the earbud.

17. The device of claim 16, wherein at least a portion of the mesh is disposed over the body acoustic port of the elongated body.

18. The device of claim 16, wherein the mesh is embedded within the elongated body and extends through the cavity.

19. A method comprising:
disposing a cavity through an elongated body of an earbud along a body axis that extends between a first end and a second end of the elongated body;
disposing a body acoustic port in the first end of the body that is acoustically coupled to the cavity of the body, wherein a portion of the cavity adjacent the body acoustic port comprises a cross-sectional area in a plane orthogonal to the body axis that increases in a direction from the second end of the body to the first end of the body;
connecting a first end of a flange to the first end of the elongated body, wherein the flange extends along the body axis between the first end and a second end, wherein the flange further comprises an opening disposed in the first end of the flange that is acoustically coupled to the cavity of the body; and
disposing a wax bridge on an outer surface of the flange along the body axis and over the body acoustic port.

20. The method of claim 19. further comprising connecting a housing of an car-wearable electronic device to the earbud.
